(19) United States
(12) Patent Application Publication
(10) Pub. No.: US 2026/0050811 A1
(43) Pub. Date: Feb. 19, 2026

(54) System and method for securing and validating interaction entities utilizing quantum computing

(71) Applicant: Bank of America Corporation, Charlotte, NC (US)

(72) Inventors: Ana Maxim, Arlington (VA); Manu Jacob Kurian, Dallas, TX (US); Vinesh Premji Patel, London (GB); Michael Robert Young, Davidson, NC (US); Freddy Alexis Cabrera, Matthews, NC (US)

(21) Appl. No.: 18/802,101

(22) Filed: Aug. 13, 2024

(51) Int. Cl. G06N 10/60; G06N 3/0475

(52) U.S. Cl. CPC G06N 10/60; G06N 3/0475

(57) ABSTRACT

A system includes a memory configured to store a plurality of instances of a software application executable on a computing device and a set of confidence scores. The system includes one or more processors operably coupled to the memory and configured to receive an interaction request for initiating an execution of an interaction, in which the interaction request includes metadata. The one or more processors may further execute one or more generative machine-learning models trained to identify, based on the interaction request and the metadata, an intent and one or more named entities included within the interaction request or the metadata, assign, based on the identified intent and one or more named entities, a confidence score to the interaction request, and generate, based on the confidence score assigned to the interaction request, a generative response including a recommendation to initiate the execution of the interaction to satisfy the interaction request.

### TECHNICAL FIELD

The present disclosure relates generally to quantum computing, and, more specifically, to a system and method for securing and validating interaction entities utilizing quantum computing.

### BACKGROUND

Certain cloud-computing based environments may include data stored across any number of databases and associated with any number of entities. For example, the data may include various user data or service data that may be stored to databases associated with respective entities, and that user data or service data may be accessed by any number of centralized or decentralized servers for servicing applications associated with various users. However, such cloud-computing based environments may be sometimes subjected to various threats and cyberattacks.

### SUMMARY

The system and methods implemented by the system as disclosed in the present disclosure provide technical solutions to the technical problems discussed above by providing systems and methods for securing and validating interaction entities utilizing quantum computing. The disclosed system and methods provide several practical applications and technical advantages. Specifically, the present embodiments improve the efficiency, accuracy, and speed of securing and validating interactions and recommendations, as well as the one or more processors and memory on which the secured and validated interactions s and recommendations may be executed and stored by securing and validating interactions utilizing quantum computing.

The present embodiments provide a combined classical computing and quantum computing system that utilizes one or more generative machine-learning models (e.g., one or more classical machine-learning (CML) models, one or more quantum machine-learning (QML) models, or some combination thereof) trained to 1) identify, based on the interaction request and metadata, an intent and one or more named entities included within the interaction request or the metadata, 2) assign, based on the identified intent and one or more named entities, a confidence score to the interaction request, and 3) generate, based on the confidence score assigned to the interaction request, a generative response including a recommendation to initiate the execution of the interaction to satisfy the interaction request.

In this way, the combined classical computing and quantum computing system may leverage the voluminous historical interactions and associated metadata that may have been submitted by various users, as well as the learnings from historical interactions successfully executed to satisfy interaction requests. Upon the combined classical computing and quantum computing system identifying that the current interaction request is associated with a confidence score that satisfies a predetermined threshold, the combined classical computing and quantum computing system may then provide a generated response that includes a recommendation to initiate the execution of an interaction to satisfy the interaction request.

Additionally, by utilizing a combined classical computing and quantum computing system, the present embodiments may improve the efficiency, accuracy, and speed of securing and validating interaction entities and recommendations. Specifically, as N quantum bits (QuBits) may represent classical binary settings in 2^{N} simultaneously or in parallel, an N-QuBit quantum computing system may simultaneously explore 2^{N} possible solutions or perform 2^{N} simultaneous or parallel searches of the voluminous historical interactions and associated metadata stored and housed by the combined classical computing and quantum computing system. Specifically, in classical computing systems alone, two classical bits can take only one of four states: 00 or 01 or 10 or 11. Each of the first bit and the second bit combines to represent only one binary configuration at a given time in a classical computing system, and thus represents a single binary configuration. However, one QuBit can exist in multiple states simultaneously. That is, the present combined classical computing and quantum computing system performs parallel processing to improve the efficiency, accuracy, and speed of securing and validating interactions and recommendations.

In this way, the combined classical computing and quantum computing system increases processing speed and reduces execution time as compared to any classical computing system alone because the combined classical computing and quantum computing system performs 2^{N} parallel operations to search the voluminous historical interactions and associated metadata and surface a recommendation based thereon. This increased processing speed and reduced execution time further allow the combined classical computing and quantum computing system to approve and/or reject interactions during the time in which a user has initiated an interaction and before the execution of the interaction has been completed (e.g., in real-time).

For example, in one embodiment, the combined classical computing and quantum computing system may implement one or more quantum algorithms (e.g., Grover's algorithm or other quantum search algorithm) to generate and return, based on the voluminous historical interactions and associated metadata, a confidence score for approving or rejecting a current interaction request (e.g., a pending interaction) of a user faster than the any existing classical computing system alone. In particular, because the combined classical computing and quantum computing system may, by way of entanglement and superposition, analyze and score voluminous historical interactions and associated metadata by performing only one operation (or just a few operations), the combined classical computing and quantum computing system may reduce search query execution time, such that the combined classical computing and quantum computing system searches a database and score surfaces a recommendation of whether to approve or reject a current interaction request (e.g., a pending interaction) of a user within just a few milliseconds.

The present embodiments are directed to systems and methods for securing and validating interaction entities utilizing quantum computing. In particular embodiments, a system includes a memory configured to store a plurality of instances of a software application executable on a computing device and a set of confidence scores. In particular embodiments, the system further includes one or more processors operably coupled to the memory and configured to receive, from at least one instance of the software application executing on the computing device, an interaction request for initiating an execution of an interaction. In one embodiment, the interaction request may include metadata associated with the interaction.

In particular embodiments, the one or more processors may be further configured to execute one or more generative machine-learning models trained to identify, based on the interaction request and the metadata, an intent and one or more named entities included within the interaction request or the metadata, assign, based on the identified intent and one or more named entities, a confidence score of the interaction request, and generate, based at least in part on the confidence score assigned to the interaction request, a generative response including a recommendation to initiate the execution of the interaction to satisfy the interaction request. In particular embodiments, the one or more generative machine-learning models may include one or more classical machine-learning (CML) models, one or more quantum machine-learning (QML) models, or a combination thereof.

In particular embodiments, each of the set of confidence scores may be assigned to the interaction request by a respective one of a plurality of trusted entities configured to independently validate interaction requests. In particular embodiments, each of the plurality of trusted entities may be configured to assign a respective confidence score to the interaction request prior to the execution of the interaction. In particular embodiments, the one or more processors may be further configured to, prior to receiving the interaction request, train the one or more generative machine-learning models based at least in part on a set of historical interactions, and assign confidence scores of the set of confidence scores to the set of historical interactions.

In particular embodiments, the one or more processors may be further configured to execute the one or more generative machine-learning models further trained to generate, based at least in part a determination that the confidence score assigned to the interaction request satisfies a threshold, the generative response including the recommendation to initiate the execution of the interaction to satisfy the interaction request. In particular embodiments, the one or more processors may be further configured to cause the at least one instance of the software application executing on the computing device to display the generative response comprising the recommendation to initiate the execution of the interaction.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a flowchart of an example method for securing and validating interaction entities utilizing quantum computing, in accordance with one or more embodiments of the present disclosure.

### DETAILED DESCRIPTION

### Example System

### System Overview

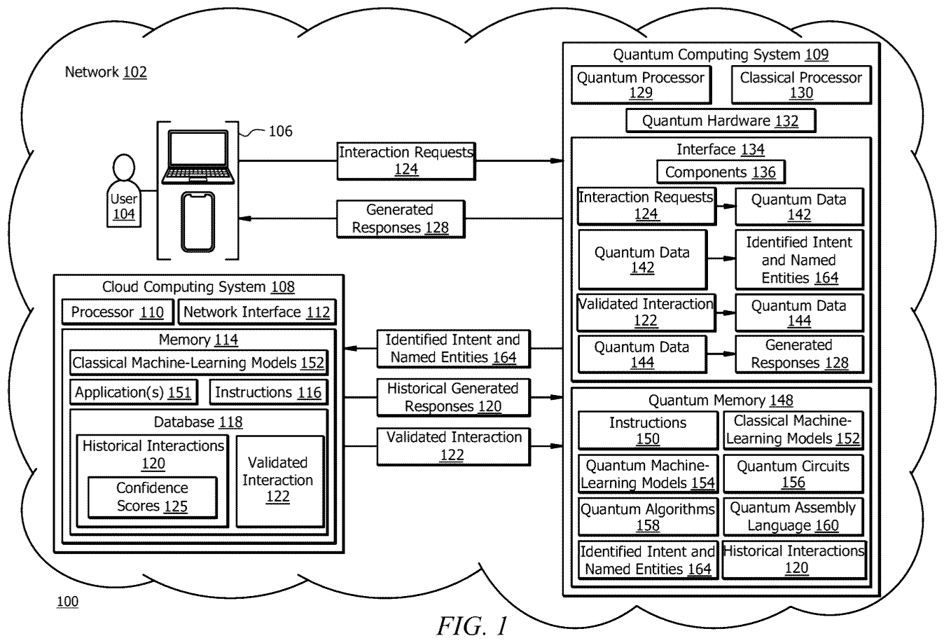

FIG. 1 is a block diagram of a combined classical computing and quantum computing system 100 and network. As depicted, the combined classical computing and quantum computing system 100 may include one or more computing devices 106 that may be associated with a user 104, a cloud computing system 108, a quantum computing system 109, and a network 102 that enables the communications between the one or more computing devices 106, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

### Network

Network 102 may be any suitable type of wireless and/or wired network. The network 102 may or may not be connected to the Internet or public network. The network 102 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 102 may be configured to support any suitable type of communication protocol as would be appreciated by one of ordinary skill in the art.

### Computing Device

Computing device 106 is generally any device that may be utilized to process data and interact with a user 104. Examples of the computing device 106 include, but are not limited to, a personal computer, a desktop computer, a workstation, a server, a laptop, a tablet computer, a mobile phone (such as a smartphone), etc. The computing device 106 may include a user interface, such as a display, a microphone, keypad, or other appropriate terminal equipment usable by the user 104. The computing device 106 may include a hardware processor, memory, and/or circuitry (not explicitly shown) configured to perform any of the functions or actions of the computing device 106 described herein. For example, a software application designed using software code may be stored in the memory and executed by the processor to perform the functions of the computing device 106. The computing device 106 may be utilized to communicate with other components of the system 100 via the network 102.

In particular embodiments, the computing device 106 may be utilized by the user 104 to communicate one or more interaction requests 124 to the quantum computing system 109 and/or the cloud computing system 108. For example, in one embodiment, the computing device 106 may execute an instance of a software application 151 that may be hosted and executed by the cloud computing system 108. In particular embodiments, the user 104 may access the instance of the software application 151 executing on the computing device 106 and provide one or more interaction requests 124 to the quantum computing system 109 and/or the cloud computing system 108.

For example, in one embodiment, the one or more interaction requests 124 may include an interaction with a third-party requested to be executed. In particular embodiments, the one or more interaction requests 124 may also include metadata (e.g., user identities, cities, countries, dates, prices, jurisdictions, products, vendors, time of day, quantities, currencies, and so forth) that may be provided along with the one or more interaction requests 124 to the quantum computing system 109 and/or the cloud computing system 108.

### Cloud Computing System

The cloud computing system 108 may include any computing that may be utilized to process data and communicate with other components of the system 100 via the network 102. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 102). The network interface 112 is configured to communicate data between the cloud computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

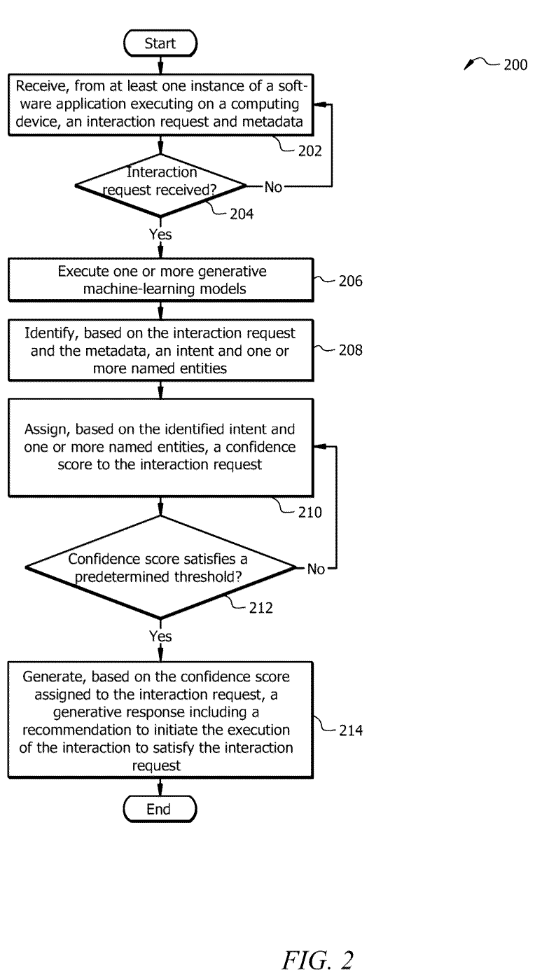

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1 and 2 along with any other data, instructions, logic, rules, or code operable to implement the function(s) described herein. The memory 114 is operable to store software instructions 116, and/or any other data and instructions. The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted structure. In one embodiment, the memory 114 may be understood to be a classical memory. In one embodiment, the memory 114 may include a non-transitory computer-readable medium.

In particular embodiments, the database 118 may store the historical interactions 120 and assigned confidence scores 125 and one or more validated interactions 122. In particular embodiments, the historical interactions 120 may include, for example, a large data set of historical interactions previously validated by the by the quantum computing system 109 and/or the cloud computing system 108 in response to previous interaction requests 124. In other embodiments, the historical interactions 120 may include, for example, a large data set of historical interactions previously utilized to train the by the quantum computing system 109 and/or the cloud computing system 108. In particular embodiments, the validated interactions 122 may include validated interactions for satisfying the one or more interaction requests 124.

In particular embodiments, the confidence scores 125 may include an indication of how well each of the historical interactions 120 and the validated interactions 122 recommended therewith performed in satisfying an associated interaction request 124. Specifically, historical interactions 120 with a confidence score of “0.7”, “0.8”, “0.9”, or greater evaluated on a scale of “0.0” to “1.0” are indicated to have performed well with respect to satisfying associated interaction requests 124. On the other hand, historical interactions 120 with a confidence score of “0.2”, “0.3”, “0.4”, or less evaluated on a scale of “0.0” to “1.0” are indicated to have performed poorly with respect to satisfying associated interaction requests 124. For example, in particular embodiments, a network of trusted entities may assign the confidence scores 125 to establish a consensus or voting quorum, such that an aggregate of the assigned confidence scores 125 may be utilized as part of an authentication process and/or an authorization process for securely validating interaction requests 124.

### Quantum Computing System

The quantum computing system 109 may include any quantum computing system that may be utilized to process data and communicate with other components of the system 100 via the network 102. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with qubits implemented by states of Josephson junctions), a trapped ion device (with qubits implemented by internal states of trapped ions), a trapped neutral atom device (with qubits implemented by internal states of trapped neutral atoms), a photon-based device (with qubits implemented by modes of photons), or any other suitable device that implements quantum bits with states of a respective quantum system. In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations. In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the identified intent and named entities 164 and the historical interactions 120.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, or other similar machine-learning model. Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks.

Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover's algorithm), quantum cryptography algorithms (e.g., Shor's algorithm), one or more quantum Fourier transform (QFT) based algorithms or inverse quantum Fourier transform (iQFT) based algorithms, one or more classical quantum hybrid algorithms (e.g., Quantum Eigensolver), one or more classical quantum variational algorithms, and/or other user-developed quantum algorithms that may be represented by instructions 150.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in particular embodiments, the interface 134 may convert interaction requests 124 represented as classical binary bits of data into quantum data 142 for inputting into one or more QML models 154, and, similarly, convert historical interactions 120 represented as classical binary bits of data into quantum data 144 for inputting into one or more QML models 154, for example. In particular embodiments, the interface 134 may be further utilized to convert data items represented by quantum bits (QuBits) of data into classical binary bits of data.

For example, in particular embodiments, upon the quantum computing system 109 generating the identified intent and named entities 164 from the interaction requests 124 based on the quantum data 142, the interface 134 may convert the quantum data 142 representing the identified intent and named entities 164 into classical binary bits of data representing the quantum data 142 representing the identified intent and named entities 164. Likewise, upon the quantum computing system 109 identifying historical interactions 120 similar to the one or more interaction requests 124, the interface 134 may convert the quantum data 144 representing the historical interactions 120 into classical binary bits of data representing the quantum data 144 representing the generated responses 128. The quantum computing system 109 may then provide the generated responses 128 to the computing device 106 associated with the user 104.

In particular embodiments, the interface 134 may include a number of components 136 that may be utilized to generate and manipulate quantum bits (QuBits. In the illustrated embodiment, the number of components 136 and the quantum processor 129 are configured to operate on a same type of quantum bits (QuBits). For example, when the quantum processor 129 includes a photon-based device (with qubits implemented by modes of photons), the number of components 136 may include optical components such as lasers, mirrors, prisms, waveguides, interferometers, optical fibers, filters, polarizers, and/or lenses.

Quantum memory 148 may include a quantum read-only memory (QROM), quantum random-access memory (QRAM), or other similar quantum memory. The quantum memory 148 may store any of the information described in FIGS. 1 and 2 along with any other data, instructions, logic, rules, or code operable to implement the function(s) described herein. The quantum memory 148 is operable to store software instructions 150, and/or any other data and instructions. The software instructions 150 may include any suitable set of software instructions, logic, rules, or code operable to be executed by the quantum processor 129. In one embodiment, the quantum memory 148 may include a non-transitory computer-readable medium.

In particular embodiments, the quantum computing system 109 may utilize one or more generative machine-learning models (e.g., one or more classical machine-learning (CML) models 152, one or more quantum machine-learning (QML) models 154, or some combination thereof) trained to 1) identify, based on the interaction request 124 and metadata, an intent and one or more named entities 164 included within the interaction request 124 or the metadata, 2) assign, based on the identified intent and one or more named entities 164, a confidence score 125 to the interaction request 124, and 3) generate, based on the confidence score 125 assigned to the interaction request 124, a generative response 128 including a recommendation to initiate the execution of the interaction to satisfy the interaction request 124.

In this way, the quantum computing system 109 may leverage the voluminous historical interactions 120 and associated metadata that may have been submitted by various users 104, as well as the learnings from historical interactions 120 successfully executed to satisfy interaction requests 124. Upon the quantum computing system 109 identifying that the current interaction request 124 is associated with a confidence score 125 that satisfies a predetermined threshold, the quantum computing system 109 may then provide a generated response 128 that includes a recommendation to initiate the execution of an interaction to satisfy the interaction request 124.

Additionally, by utilizing the quantum computing system 109, the present embodiments may improve the efficiency, accuracy, and speed of securing and validating interaction entities and recommendations. Specifically, as N quantum bits (QuBits) may represent classical binary settings in 2^{N} simultaneously or in parallel, an N-QuBit quantum computing system may simultaneously explore 2^{N} possible solutions or perform 2^{N} simultaneous or parallel searches of the voluminous historical interactions 120 and associated metadata stored and housed by the quantum computing system 109.

For example, in one embodiment, the quantum computing system 109 may implement one or more quantum algorithms (e.g., Grover's algorithm or other quantum search algorithm) to generate and return, based on the voluminous historical interactions 120 and associated metadata, a confidence score 125 for approving or rejecting a current interaction request 124 of the user 104 faster than the any existing classical computing system 108 alone. In particular, because the quantum computing system 109 may, by way of entanglement and superposition, analyze and score voluminous historical interactions 120 and associated metadata by performing only one operation (or just a few operations), the quantum computing system 109 may reduce the time spent searching any sorted database and/or unsorted database and return a recommendation of whether to approve or reject a current interaction request 124 of the user 104 within just a few milliseconds.

### Securing and Validating Interaction Entities Utilizing Quantum Computing

FIG. 2 illustrates a flowchart of an example method 200 for securing and validating interaction entities utilizing quantum computing, in accordance with one or more embodiments of the present disclosure. The method 200 may be performed by the combined classical computing and quantum computing system 100 as described above with respect to FIG. 1. For example, in one embodiment, the method 200 may be performed by the cloud computing system 108 alone. In another embodiment, the method 200 may be performed by the quantum computing system 109 alone. In yet another embodiment, the method 200 may be performed in conjunction by the cloud computing system 108 and the quantum computing system 109.

The method 200 may begin at block 202 with the cloud computing system 108 and/or the quantum computing system 109 receiving, from at least one instance of a software application executing on a computing device, an interaction request 124. In one embodiment, the interaction request 124 may be associated with metadata describing aspects of the interaction request 124. In particular embodiments, the method 200 may continue at decision 204 with the cloud computing system 108 and/or the quantum computing system 109 confirming whether the interaction request 124 and the associated metadata has been received. In particular embodiments, in response to determining that the interaction request 124 and associated metadata has not been received (e.g., at decision 204), the method 200 may return to block 202. On the other hand, in response to determining that the interaction request 124 and associated metadata has been received (e.g., at decision 204), the method 200 may continue at block 206 with the cloud computing system 108 and/or the quantum computing system 109 executing one or more generative machine-learning models (e.g., CML models 152, QML models 154).

In particular embodiments, the method 200 may continue at block 208 with the cloud computing system 108 and/or the quantum computing system 109 (e.g., utilizing the CML models 152, QML models 154, or some combination thereof) identifying, based on the interaction request and the associated metadata, an intent and one or more named entities 164 included within the interaction request 124 or associated metadata. The method 200 may continue at block 210 with the cloud computing system 108 and/or the quantum computing system 109 (e.g., utilizing the CML models 152, QML models 154, or some combination thereof) assign, based on the identified intent and one or more named entities 164, a confidence score 125 to the interaction request 124.

The method 200 may then continue at decision 212 with the cloud computing system 108 and/or the quantum computing system 109 (e.g., utilizing the CML models 152, QML models 154, or some combination thereof) confirming whether the confidence score 125 assigned to the interaction request 124 satisfies a predetermined threshold. In particular embodiments, in response to confirming that the confidence score 125 assigned to the interaction request 124 does not satisfy the predetermined threshold (e.g., at decision 212), the method 200 may return to block 210.

In particular embodiments, in response to confirming that the confidence score 125 assigned to the interaction request 124 satisfies the predetermined threshold (e.g., at decision 212), the method 200 may conclude at block 214 with the cloud computing system 108 and/or the quantum computing system 109 (e.g., utilizing the CML models 152, QML models 154, or some combination thereof) generating, based on the confidence score 125 assigned to the interaction request 124, a generative response 128 including a recommendation to initiate the execution of the interaction to satisfy the interaction request 124.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S. C. § 112(f) as it exists on the date of filing hereof unless the words “means for” or “step for” are explicitly used in the particular claim.

1. A system, comprising:
a memory configured to store a plurality of instances of a software application executable on a computing device and a set of confidence scores; and
one or more processors operably coupled to the memory and configured to:
receive, from at least one instance of the software application executing on the computing device, an interaction request for initiating an execution of an interaction, wherein the interaction request comprises metadata associated with the interaction; and
execute one or more generative machine-learning models trained to:
identify, based on the interaction request and the metadata, an intent and one or more named entities included within the interaction request or the metadata;
assign, based on the identified intent and one or more named entities, a confidence score to the interaction request; and
generate, based at least in part on the confidence score assigned to the interaction request, a generative response comprising a recommendation to initiate the execution of the interaction to satisfy the interaction request.

2. The system of claim 1, wherein the one or more generative machine-learning models comprises one or more classical machine-learning (CML) models, one or more quantum machine-learning (QML) models, or a combination thereof.

3. The system of claim 1, wherein each of the set of confidence scores is assigned to the interaction request by a respective one of a plurality of trusted entities configured to independently validate interaction requests.

4. The system of claim 3, wherein each of the plurality of trusted entities is configured to assign a respective confidence score to the interaction request prior to the execution of the interaction.

5. The system of claim 1, wherein the one or more processors are further configured to:
prior to receiving the interaction request:
train the one or more generative machine-learning models based at least in part on a set of historical interactions; and
assign confidence scores of the set of confidence scores to the set of historical interactions.

6. The system of claim 1, wherein the one or more processors are further configured to:
execute the one or more generative machine-learning models further trained to:
generate, based at least in part a determination that the confidence score assigned to the interaction request satisfies a threshold, the generative response comprising the recommendation to initiate the execution of the interaction to satisfy the interaction request.

7. The system of claim 1, wherein the one or more processors are further configured to:
cause the at least one instance of the software application executing on the computing device to display the generative response comprising the recommendation to initiate the execution of the interaction.

8. A method, comprising:
receiving, from at least one instance of a software application executing on a computing device, an interaction request for initiating an execution of an interaction, wherein the interaction request comprises metadata associated with the interaction; and
executing one or more generative machine-learning models trained to:
identify, based on the interaction request and the metadata, an intent and one or more named entities included within the interaction request or the metadata;
assign, based on the identified intent and one or more named entities, a confidence score to the interaction request; and
generate, based at least in part on the confidence score assigned to the interaction request, a generative response comprising a recommendation to initiate the execution of the interaction to satisfy the interaction request.

9. The method of claim 8, wherein the one or more generative machine-learning models comprises one or more classical machine-learning (CML) models, one or more quantum machine-learning (QML) models, or a combination thereof.

10. The method of claim 8, wherein each of a set of confidence scores is assigned to the interaction request by a respective one of a plurality of trusted entities configured to independently validate interaction requests.

11. The method of claim 10, wherein each of the plurality of trusted entities is configured to assign a respective confidence score to the interaction request prior to the execution of the interaction.

12. The method of claim 8, further comprising:
prior to receiving the interaction request:
training the one or more generative machine-learning models based at least in part on a set of historical interactions; and
assigning confidence scores of the set of confidence scores to each of the set of historical interactions.

13. The method of claim 8, further comprising:
executing the one or more generative machine-learning models further trained to:
generate, based at least in part a determination that the confidence score assigned to the interaction request satisfies a threshold, the generative response comprising the recommendation to initiate the execution of the interaction to satisfy the interaction request.

14. The method of claim 8, further comprising causing the at least one instance of the software application executing on the computing device to display the generative response comprising the recommendation to initiate the execution of the interaction.

15. A non-transitory computer-readable medium storing instructions that, when executed by one or more processors, cause the one or more processors to:
receive, from at least one instance of a software application executing on a computing device, an interaction request for initiating an execution of an interaction, wherein the interaction request comprises metadata associated with the interaction; and
execute one or more generative machine-learning models trained to:
identify, based on the interaction request and the metadata, an intent and one or more named entities included within the interaction request or the metadata;
assign, based on the identified intent and one or more named entities, a confidence score to the interaction request; and
generate, based at least in part on the confidence score assigned to the interaction request, a generative response comprising a recommendation to initiate the execution of the interaction to satisfy the interaction request.

16. The non-transitory computer-readable medium of claim 15, wherein the one or more generative machine-learning models comprises one or more classical machine-learning (CML) models, one or more quantum machine-learning (QML) models, or a combination thereof.

17. The non-transitory computer-readable medium of claim 15, wherein each of a set of confidence scores is assigned to the interaction request by a respective one of a plurality of trusted entities configured to independently validate interaction requests.

18. The non-transitory computer-readable medium of claim 17, wherein each of the plurality of trusted entities is configured to assign a respective confidence score to the interaction request prior to the execution of the interaction.

19. The non-transitory computer-readable medium of claim 15, wherein the instructions further cause the one or more processors to:
prior to receiving the interaction request:
train the one or more generative machine-learning models based at least in part on a set of historical interactions; and
assign confidence scores of the set of confidence scores to the set of historical interactions.

20. The non-transitory computer-readable medium of claim 15, wherein the instructions further cause the one or more processors to:
execute the one or more generative machine-learning models further trained to:
generate, based at least in part a determination that the confidence score assigned to the interaction request satisfies a threshold, the generative response comprising the recommendation to initiate the execution of the interaction to satisfy the interaction request.
